(19) United States
(12) Patent Application Publication
(10) Pub. No.: US 2006/0286372 A1
(43) Pub. Date: Dec. 21, 2006

(54) High heat-dissipating lubricant aluminum-based cover plate and production process thereof

(75) Inventors: Tai-Wein Chien, Taoyuan Hsien (TW); Chun-Fu Liu, Taoyuan Hsien (TW); Chun-Ching Liao, Taoyuan Hsien (TW)

Correspondence Address: TROXELL LAW OFFICE PLLC;SUITE 1404, 5205 LEESBURG PIKE, FALLS CHURCH, VA, 22041, US

(73) Assignee: Uniplus Electronics Co., Ltd.

(21) Appl. No.: 11/156,731

(22) Filed: Jun. 21, 2005

(51) Int. Cl. B32B 15/08; B32B 15/09; B32B 15/092; B32B 15/20

(52) U.S. Cl. 428/337; 428/458; 428/461; 428/418; 428/523; 428/522; 428/339; 156/280

(57) ABSTRACT

A high heat-dissipating lubricant aluminum-based cover plate and production process thereof comprises a composite material, an aluminum foil layer and a lubricant layer, wherein said composite material is composed of a core material associated at its rear side with a cast film, said aluminum foil layer is associated by pressing under heat with said cast film of said composite material, and said lubricant layer is applied over the surface of said core material of said composite material and is one selected from nonyl phenol polyethylene glycol ether, polyethylene glycol (PEG), polyvinyl alcohol (PVA) and water soluble epoxy resin, or mixtures of equal ratio thereof; thereby, during drilling, a drilling point can be lubricated by said lubricant layer first and hence its piercing force can be buffered.

### BACKGROUND OF THE INVENTION

1. Field of the Invention

The invention relates to a high heat-dissipating lubricant aluminum-based cover plate and production process thereof, and in particular, to a high heat-dissipating lubricant aluminum-based cover plate provided with a lubricant layer for lubricating drilling point and buffering its piercing force, characterized in that said cover plate has a simple structure, can extend the service life of the drilling point, and, by means of dry (heating and pressing) and wet (casting, coating) production processes, the production progress can be effectively increased and a flat and uniform material can be obtained, and is applicable to drilling apparatus for printed circuit board.

2. Description of the Prior Art

In recent years, as the electronic technology is improved continuously and a number of high technical electronic industries are provided constantly, many new humanized, better functional electronic products are developed in a tendency toward lighter, thinner, shorter, and smaller designs. In general, each electronic product has at least a mother board constructed from many electronic elements and circuit boards wherein said circuit board functions to support and connect electrically these electronic elements such that these electronic elements can be connected electrically. The most commonly used circuit board at present is the printed circuit board (PCB).

The printed circuit board can connect electronic elements such that the function derived from these electronic elements can be functioned as a whole, and therefore, PCB becomes an essential basic construction member for all the electronic products. Since the quality of a printed circuit board may not only influence the reliability of an electronic product, but also can determine the competitive force of the systematic product made therefrom, the PCB therefore is often referred as “the mother of an electronic systematic product” or as “the fundamental of the 3C industry”. PCB comprises a substrate made of non-conductive material. On this substrate, there are many pre-drilled holes for mounting chips and other electronic elements. These pre-drilled holes for elements can facilitate the electrical connection of the metal path defined by printing previously on the substrate. By penetrating connecting legs of electronic elements through PCB and adhering these legs with conductive metal solder on PCB, an electric circuit is thus formed.

When drilling the circuit board, small drilling point should be employed for holes of small diameter, and consequently, small drilling point may break frequently. In the state of art, in order to drill smoothly, and to reduce the incidence of breaking, an aluminum-based buffering material is placed on the circuit board prior to drilling so as to buffer the drilling point and to dissipate heat during drilling. Nevertheless, the possibility of the conventional buffering material to reduce breaking of the drilling point is limited yet, the stability of the drilling point in use is somewhat insufficient and further, the formulation and production process for conventional buffering materials is complicated such that the production rate and the flatness of the material would be influenced.

In view of the foregoing disadvantages associated with the conventional technology, the inventor had devoted to improve, and finally, after studying intensively, provided successfully a high heat-dissipating lubricant aluminum-based cover plate and production process thereof according to the invention.

### SUMMARY OF THE INVENTION

One objective of the invention is to provide a high heat-dissipating lubricant aluminum-based cover plate and production process thereof characterized in that it can reduce effectively the breaking incidence of drilling point and increase efficiently the stability of the drilling point during drilling.

Another objective of the invention is to provide a high heat-dissipating lubricant aluminum-based cover plate and production process thereof characterized in that it can simplify the type of resins used in the current technique, and can accelerate the production rate by using simultaneously a dry and a wet processes to obtain a flat and uniform material.

In order to achieve the above-described objectives, the high heat-dissipating lubricant aluminum-based cover plate and production process thereof provided by the invention comprises a composite material, an aluminum foil layer and a lubricant layer, wherein said composite material is composed of a core material associated at its rear side with a cast film, said aluminum foil layer is associated with said cast film of said composite material by heating and pressing processes, and said lubricant layer is applied over said core material of said composite material and is one selected from nonyl phenol polyethylene glycol ether, polyethylene glycol (PEG), polyvinyl alcohol (PVA) and water soluble epoxy resin, or mixtures of equal ratio thereof; thereby, during drilling, said drilling point can be lubricated by said lubricant layer first and hence its piercing force can be buffered.

### BRIEF DESCRITPION OF THE DRAWINGS

The drawings disclose an illustrative embodiment of the present invention which serves to exemplify the various advantages and objectives hereof, and are as follows:

FIG. 1 is a sectional view showing the assembled high heat-dissipating lubricant aluminum-based cover plate according to the invention.

FIG. 2 is a flow chart showing the production process of the high heat-dissipating lubricant aluminum-based cover plate according to the invention.

FIG. 3 is a sectional view showing the state when the high heat-dissipating lubricant aluminum-based cover plate according to an embodiment of the invention is used for drilling a printed circuit board.

FIG. 4 is a view showing the accuracy test performed on the high heat-dissipating lubricant aluminum-based cover plate according to the invention.

FIG. 5 is a view showing the accuracy test performed on a conventional pure aluminum foil product (200 μm).

FIG. 6 is a view showing the accuracy test performed on a conventional “ALPC” product.

FIG. 7 is a view showing the accuracy test performed on a conventional “LE800” product.

### DETAILED DESCRIPTION OF THE PREFERRED EMBODIMENT

In order to understand further deeply the invention, following non-limiting example is illustrated in detailed.

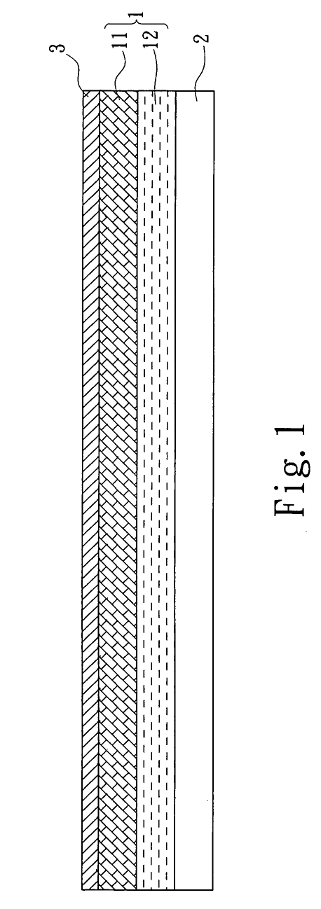

Referring to FIG. 1, an embodiment of the high heat-dissipating lubricant aluminum-based cover plate according to the invention is shown, and comprises a composite material 1, an aluminum foil layer 2 and a lubricant layer 3.

Said composite material 1 is composed of a core material 11 provided at its rear side with a cast film layer 12. Said core material 11 is an organic material or a semi-organic material with a thickness of 20 μm to 200 μm. Said cast film layer 12 is formed by casting a mixture of polyethylene (PE), polypropylene (PP), polyvinyl ester or polyacrylonitrile blended with an inorganic filler on said core material to a thickness of 12 μm to 100 μm. Said inorganic filler may be one selected from aluminum oxide (Al₂O₃), magnesium oxide (MgO), zinc oxide (ZnO), titanium dioxide (TiO₂), calcium carbonate (CaCO₃), AIN, BN, Al₂(OH)₃, graphite, aluminum, and copper.

Said aluminum foil layer 2 is stuck over said cast film layer 12 of said composite material 1 by pressing under heat to a thickness of 50 μm to 200 μm.

Said lubricant layer 3 is applied over the surface of said core material 11 of said composite material 1, and is a material selected from nonyl phenol polyethylene glycol ether, polyethylene glycol (PEG), polyvinyl alcohol (PVA) and water soluble epoxy resins, or a mixture of equal ratio thereof, or a mixture of said material in admixture with an alcohols or water.

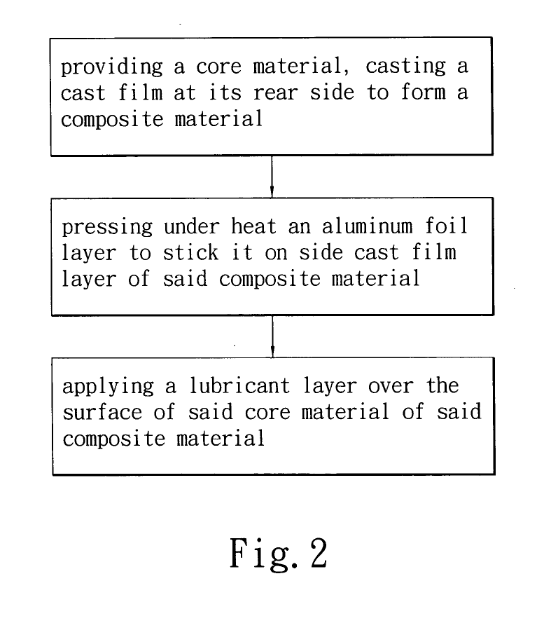

When producing, a process as shown in FIG. 2 is employed, and it comprises of providing an organic or semi-organic material as the core material 11. In an embodiment of the invention, a Kraft is used as the core material 11. In this case, a cast film 12 is formed by casting a mixture of one material selected from PE, PP, polyvinyl ester of polyacrylonitrile blended with inorganic filler to a thickness of 12 μm to 100 μm over said Kraft core material 11 with a thickness of 20 μm to 200 μm. Said cast film 12 is then pressed under heat to stick on said aluminum foil layer 2 in a manner that said cast film 12 is deposited between said Kraft core material 11 and said aluminum foil layer 2. Finally, a lubricant layer 3 is applied over the opposite surface of said Kraft core material 11 by one process selected from roller coating, spin coating, cast coating, and spray coating, and then air dried.

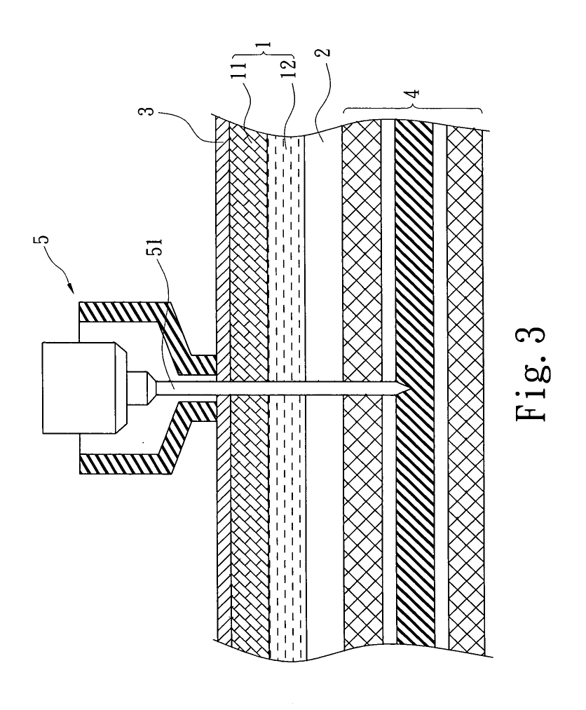

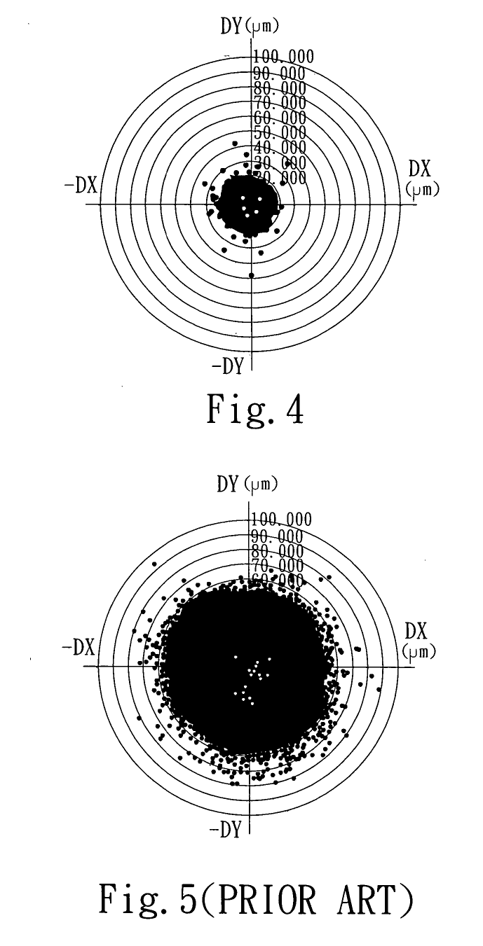

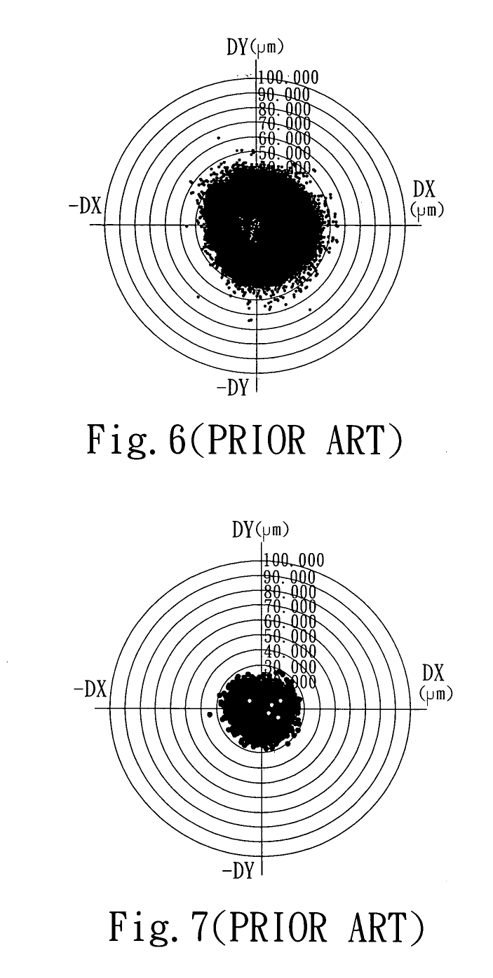

Thus, as shown in FIG. 3, when the high heat-dissipating lubricant aluminum-based cover plate for drilling produced as described above is placed on a printed circuit board 4 to carry out drilling operation, as the drilling apparatus 5 reaches a predetermined drilling position, the drilling point 51 is allowed to lower and drill. As the drilling point 51 lowering, it will pass first through the lubricant layer 3 provided according to the invention, such that said drilling point 51 can be lubricated and its piercing force can be buffered so as to prevent the drilling point 51 from breaking and the deviation of the hole can be avoided. Further, heat generated during drilling can be dissipated by means of said aluminum foil layer 2 and the heat dissipating cast film layer 12 so as to reduce the effect on the quality of the printed circuit board 4 by the heat from friction during drilling, and to extend the service life of the drilling point.

To understand the possibility of improving efficiently the drilling quality by the high heat-dissipating lubricant aluminum-based cover plate according to the invention, an embodiment is provided and is compared with a current conventional cover plate. Formulation of lubricant layer used in this embodiment of the invention comprises 20 wt % of nonyl phenol polyethylene glycol ether, 40 wt % of polyethylene glycol (molecular weight: 2000) and 40 wt % of a water soluble epoxy resin (molecular weight: 900).

| | Pure Al foil | | | |
|---|---|---|---|---|
| | (200 μm) | ALPC | LE800 | LAC |
| | (A commercial | (A commercial | (A commercial | (The |
| | product) | product) | product) | invention) |
| Cpk | 1.333 | 1.625 | 3.865 | 4.369 |
| (accuracy) | | | | |
| Accuracy | | | | |

(Diameter of a hole: 0.2 mm, accuracy: 50 μm; 3 sheet/one drill/thickness of each sheet: 0.4 mm)

In summary, the high heat-dissipating lubricant aluminum-based cover plate and production process thereof according to the invention has following advantages over conventional technique:
1. Since the high heat-dissipating lubricant aluminum-based cover plate and production process thereof according to the invention is provided with a lubricant layer consisted of one material selected from nonyl phenol polyethylene glycol ether, polyethylene glycol (PEG), polyvinyl alcohol (PVA) and water soluble epoxy resin, or a mixture of equal ratio thereof, or a mixture of said material in admixture with an alcohols or water, when carrying out a drilling operation, said drilling point can be lubricated and its piercing force can be buffered by said lubricant layer so as to prevent the drilling point from breaking and the deviation of the hole can be avoided. Further, heat generated during drilling can be dissipated by means of said aluminum foil layer and the heat dissipating cast film layer so as to reduce the effect on the quality of the printed circuit board by the heat from friction during drilling, and to extend the service life of the drilling point.
2. The high heat-dissipating lubricant aluminum-based cover plate according to the invention has a simple structure, and, by means of dry (heating and pressing) and wet (casting, coating) production processes, the production progress can be effectively increased and a flat and uniform material can be obtained.

While the invention has been described with reference to embodiments thereof, it is understood that these should not be construed to limit the scope of the invention. Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A high heat-dissipating lubricant aluminum-based cover plate for buffering the drilling of a printed circuit board, said cover plate comprising:
a composite material, composed of a core material associated at its rear side with a cast film layer;
an aluminum foil layer, for binding over said cast film layer of said composite material; and
a lubricant layer, applied on the surface of said core material of said composite material, and comprising a material selected from nonyl phenol polyethylene glycol ether, polyethylene glycol (PEG), polyvinyl alcohol (PVA) and water soluble epoxy resin, or a mixture of equal ratio thereof;
wherein, during drilling, a drilling point can pass first through said lubricant layer and hence can be lubricated by said lubricant layer and its piercing force can be buffered.

2. A high heat-dissipating lubricant aluminum-based cover plate for drilling as claimed in claim 1, wherein said core material is an organic material or a semi-organic material with a thickness of 20 μm to 200 μm.

3. A high heat-dissipating lubricant aluminum-based cover plate for drilling as clamed in claim 1, wherein said cast film layer is formed by casting a mixture of polyethylene (PE), polypropylene (PP), polyvinyl ester or polyacrylonitrile blended with an inorganic filler on said core material to a thickness of 12 μm to 100 μm.

4. A high heat-dissipating lubricant aluminum-based cover plate for drilling as claimed in claim 3, wherein said inorganic filler is one selected from aluminum oxide (Al₂O₃), magnesium oxide (MgO), zinc oxide (ZnO), titanium dioxide (TiO₂), calcium carbonate (CaCO₃), AIN, BN, Al₂(OH)₃, graphite, aluminum, and copper.

5. A high heat-dissipating lubricant aluminum-based cover plate for drilling as claimed in claim 1, wherein said aluminum foil layer has a thickness of 50 μm to 200 μm.

6. A high heat-dissipating lubricant aluminum-based cover plate for drilling as claimed in claim 1, wherein said aluminum foil layer is stuck on said cast film layer of said composite material by pressing under heat.

7. A high heat-dissipating lubricant aluminum-based cover plate for drilling as claimed in claim 1, wherein said lubricant layer is applied over the surface of said core material of said composite material by a process selected from roller coating, spin coating, cast coating, and spray coating.

8. A high heat-dissipating lubricant aluminum-based cover plate for drilling as claimed in claim 1, wherein said lubricant layer is blended further with alcohol or water.

9. A high heat-dissipating lubricant aluminum-based cover plate for drilling as claimed in claim 1, wherein, in said lubricant layer, the polyethylene glycol has a molecular weight between 1000 and 12000, and said water soluble epoxy resin has a molecular weight between 500 and 20000.

10. A process for producing a high heat-dissipating lubricant aluminum-based cover plate for drilling, comprising following steps:
a. providing a core material, casting a cast film at its rear side to form a composite material;
b. pressing under heat an aluminum foil layer to stick it on said cast film layer of said composite material; and
c. applying a lubricant layer over the surface of said core material of said composite material.
